(19) United States
(12) Patent Application Publication
(10) Pub. No.: US 2002/0190451 A1
(43) Pub. Date: Dec. 19, 2002

(54) Fiber-reinforced composite springs

(75) Inventors: Erol Sancaktar, Tallmadge, OH (US); Sunil Gowrishankar, Akron, OH (US)

Correspondence Address: RENNER, KENNER, GREIVE, BOBAK, TAYLOR & WEBER, FOURTH FLOOR, FIRST NATIONAL TOWER, AKRON, OH, 44308, US

(73) Assignee: The University of Akron

(21) Appl. No.: 09/871,755

(22) Filed: Jun. 1, 2001

(51) Int. Cl. F16F 1/06

(52) U.S. Cl. 267/166

(57) ABSTRACT

A fiber-reinforced composite spring comprising a coiled spring wire that comprises a fiber-reinforced core having longitudinal axis, where the core comprises core-reinforcing fiber tows that are twisted about the longitudinal axis of the core, and an outer layer surrounding the fiber-reinforced core, where the outer layer comprises a resin that is devoid of fiber tows.

### TECHNICAL FIELD

This invention relates to fiber-reinforced composite springs and methods for making the same.

### BACKGROUND OF THE INVENTION

Composite springs are known. The method of manufacturing these springs has a major influence on their final properties. Traditionally, composite springs have been made by impregnating fiber yarns, such as glass or carbon yarns, with a suitable resin. The impregnated fibers are then carefully wrapped with a water-soluble tape such as a polyvinyl alcohol tape. The wrapped fibers are then placed onto a grooved mandrel and cured at elevated temperatures. The wrapping tape is then removed by soaking the final product in water. This process, however, is tedious and labor intensive, and results in an inferior composite spring because the spring surface is not smooth; it contains a spiral pattern created by the presence of the polyvinyl alcohol tape. This pattern affects the deformational performance of the spring, which results in an unpredictable load versus deformation behavior. As a result, specialized equipment is requires to induce uniform wrapping. Furthermore, springs that have non-circular wire cross-sections cannot be made with this wrapping method.

### SUMMARY OF INVENTION

In general the present invention provides a fiber-reinforced composite spring comprising a coiled spring wire that comprises a fiber-reinforced core having longitudinal axis, where the core comprises core-reinforcing fiber tows that are twisted about the longitudinal axis of the core, and an outer layer surrounding the fiber-reinforced core, where the outer layer comprises a resin that is devoid of fiber tows.

The present invention also includes a fiber-reinforced composite spring formed by a process comprising the steps of impregnating a bundle of fiber tows with a thermosetting resin composition to form a bundle of impregnated fiber tows, twisting the bundle of impregnated fibers to form a twisted bundle of fibers, applying a shroud over the twisted bundle of fibers twisting the twisted bundle of fibers within the shroud, winding the twisted bundle of fibers within the shroud around a mandrel to form a pre-set coil, allowing the pre-set coil to cure, and removing the shroud.

The present invention further includes a process for forming a fiber-reinforced composite spring comprising the steps of impregnating a bundle of fiber tows with a thermosetting resin composition to form a bundle of impregnated fiber tows, twisting the bundle of impregnated fibers to form a twisted bundle of fibers, applying a shroud over the twisted bundle of fibers, twisting the twisted bundle of fibers within the shroud, winding the twisted bundle of fibers within the shroud around a mandrel to form a pre-set coil, allowing the pre-set coil to cure, and removing the shroud.

Advantageously, the fiber-reinforced composite springs of this invention can have circular or non-circular wire cross-sections, and they exhibit predictable load versus deformation behavior. Also, they exhibit increased fatigue life due to the absence of any surface irregularities. Also, the process of this invention advantageously allows one to produce composite springs that have a smooth surface, which is comprised of a continuous polymer layer having a desired thickness.

### BRIEF DESCRIPTION OF THE DRAWINGS

FIG. 1 is an elevational view of a fiber-reinforced composite spring with a circular wire cross-section according to this invention.

FIG. 2 is a cross-sectional view of a spring wire having a circular cross-section according to this invention.

FIG. 3 is a cross-sectional view of an embodiment of this invention where the spring wire has a rectangular cross-section.

FIG. 4 includes four separate embodiments of this invention wherein the composite spring can be constructed with a variable pitch-variable shape (A), a barrel shape (B), an hourglass shape (C), and a conical shape (D).

FIG. 5 includes perspective views of two embodiments of the present invention that include fiber-reinforced composite helical tension springs of circular cross-section that include a half-loop end (A), or a reduced diameter end coil (B).

FIG. 6 is an elevational view of a circular cross-section shroud wrapped around a conical mandrel wherein the shroud includes fiber yarns and resin according to this invention.

### PREFERRED EMBODIMENT FOR CARRYING OUT THE INVENTION

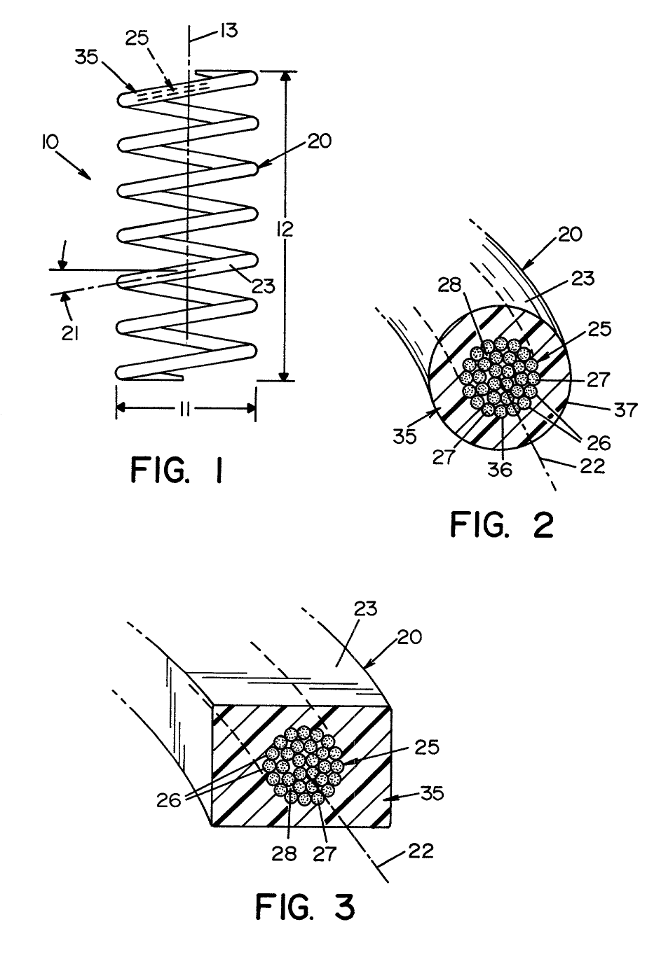

The fiber-reinforced composite spring of this invention is shown in FIG. 1. Spring 10 includes a coiled spring wire 20, which is coiled at a helix angle 21. The cross-section of spring wire 20 is shown in FIGS. 2 and 3, where fiber-reinforced core 25 and an outer layer 35 are shown.

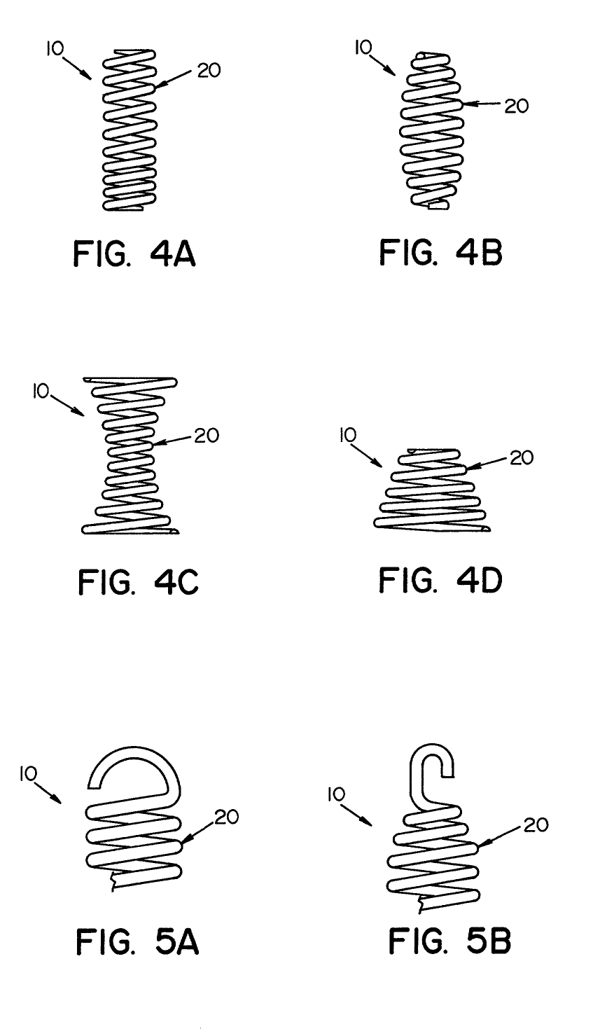

With reference to FIG. 1, spring 20 has a coil diameter 11 and a length 12. Both coil diameter 11 and length 12 can vary based upon the desired application. Likewise, helix angle 21 can vary based upon the desired application. Varying helix angle 21 within the same spring will result in a variable rate spring as shown in FIG. 4A.

Also, coil diameter 11 can vary along the longitudinal axis 13 of spring 10. For example, if the coil diameter decreases towards both ends of the spring, a barrel will be formed as shown in FIG. 4B. If the coil diameter increases towards both ends of the spring, an hourglass spring will be formed as shown in FIG. 4C. If the coil diameter increases toward one end of the spring, a conical spring will be formed as shown in FIG. 4D. If an end hook is added as shown in FIGS. 5A and 5B, the spring can be used in tension.

The cross-sectional shape of spring wire 20 may also vary, with circular, rectangular, and square cross-sections being the most commonly used. In one embodiment, as shown in FIG. 2, the cross-sectional shape of spring wire 20 is circular. In another embodiment, as shown in FIG. 3, the cross-sectional shape of spring wire 20 is rectangular. Although not shown, the cross-sectional shape of spring wire 20 may include a myriad of different shapes.

As shown in FIGS. 2 and 3, fiber-reinforced core 25 preferably includes a plurality of fiber bundles 26. This core also may include a resin matrix 28 that is formed by impregnating the plurality of bundles 26 with a resin. Bundles 26 preferably include a plurality of tows 27. A tow refers to a plurality of filaments. The number of individual filaments within a tow is typically quantified by using a “K” value, which refers to 1,000 individual filaments; e.g., 46K refers to a tow having 46,000 individual filaments.

The plurality of bundles 26 are twisted about the longitudinal axis 22 of coiled spring wire 20. Likewise, the tows within a bundle may be twisted around one another about longitudinal axis 22 of coiled spring wire 20. Still further, the individual filaments within a tow may be twisted around one another.

Useful fibers include both natural and synthetic fibers. Natural fibers may include, but are not limited to, jute and rayon of a cellulosic origin. Inorganic type fibers may include, but are not limited to, glass, carbon, boron, silicon carbide, aluminum oxide, quartz, alumina-silica, alumina-boria-silica, zirconia-silica, and fused silica fibers. Organic-type fibers may include, but are not limited to, polyamide fibers including aromatic aramids such as Kevlar™, nylon, polyester, ultra-high molecular weight polyethylene, and polybenzimidazole. Metallic fibers may include, but are not limited to, steel, aluminum, nickel, silver, and gold. Bundle 26 may include a mixture of these fibers or fiber tows.

Resin matrix 28 is typically formed by impregnating bundles 26 with a resin. The resin may comprise a thermosetting resin or a thermoplastic resin. The resin may also include other additives such as rubber tougheners, natural layered silicates (smectites) including montmorillonite and hectorite, carbon, chopped fibers, and the like. Useful resins include epoxy, bis-maleimide, polyimide, polyester, and vinyl ester resins, as well as polyether, ether ketone, polyphenylene sulfide, polyetherimide, and polyamide imide resins. Useful thermoplastic resins include those that can be dissolved in a solvent that allows them to impregnate the yarn bundles.

Outer layer 35 typically comprises the same resin as resin matrix 28. Accordingly, outer layer 35 may comprise thermosetting or thermoplastic resins. Outer layer 35 is devoid of any fiber yarns. In other words, outer layer 35 does not include any yarn wrappings or wound fiber reinforcements, and outer layer 35 is not encased in any yarn wrappings or fiber yarn reinforcements. As a result, spring element 20 has a smooth outer surface 23. This advantageously provides predictable spring behavior and longer fatigue life.

Preferably, outer layer 35 of spring element 20 has a uniform thickness. The thickness of outer layer 35 is measured from an inner point 36, which is where the outer layer meets the core, to an outer point 37, which is the outermost surface of the spring. The term “uniform thickness” refers to the fact that no fiber bundles will be exposed on the spring surface, and that there will be an outer layer of resin all throughout the spring surface, and that the surface will be smooth without any ridges or patterns. Preferably, the thickness will not vary by more than 10%, more preferably by not more than 7%, and even more preferably by not more than 5% over the longitudinal axis 22 of coiled spring wire 20. This will remain true regardless of the cross-sectional shape of spring element 20. In the embodiment where the cross-sectional shape is circular, the thickness of outer layer 35 will likewise be uniform at all points within the cross-section of spring element 20. This, of course, will not be true where the cross-sectional shape of spring element 20 is a different shape such as a rectangle as shown in FIG. 4. Nonetheless, so long as the thickness is measured from a consistent inner point 36 and a consistent outer point 37 across longitudinal axis 22 of coiled spring wire 20, the thickness of outer layer 35 will be uniform along the longitudinal axis 22.

In general, the fiber-reinforced composite springs of this invention are prepared by impregnating a bundle of fiber tows with a resin composition, twisting the bundle of impregnated tows, applying a shroud over the twisted bundle, twisting the bundle of tows within the shroud, winding the shroud around the mandrel, allowing the resin to set, and removing the shroud.

The fiber tows can be bundled by using a variety of techniques. For example, a predetermined number of tows can be cut to a desired length and lightly stretched between two clamps. When bundling these tows, tows of similar composition and diameter can be employed. Alternatively, tows of varying composition and diameter can be employed. Also, one can mix tows of different fiber materials. This can be done simply by sequentially adding tows to the bundle.

Various techniques for impregnating the bundled fibers can be employed. For example, the bundled tows can be submerged into a bath of resin. Other methods include pultrusion of the bundle through molten thermoplastic or liquid resin. Still other techniques include transfer of the resin to the lightly stretched bundle by brush, sponge, fabric or any other absorbent material by wiping or swiping the bundle through this material.

To accomplish this step, it is preferred that the resin be in the form of a liquid. Typically, two part epoxy resins are in the form of a liquid until the epoxy sets. Where a thermoplastic resin is used, the thermoplastic can be dissolved or liquified by using a solvent. If a pultrusion method is used, the bundle can simply by pulled through the molten plastic material. The final diameter of the fiber/resin composite wire to be obtained impacts the magnitude of the spring constant (also called spring rate or stiffness), i.e., the applied force divided by the spring deflection. The spring constant is directly proportional to the fourth power of the wire diameter. The final mechanical properties of the spring wire obtained by this method also impacts the magnitude of the spring constant. The spring constant is directly proportional to the shear modulus of the spring wire.

The impregnated bundle of fibers can be twisted by using a variety of techniques. In one preferred embodiment, the impregnated yarns are twisted by using a filament winding machine. These machines are known in the art and are available from the Composite Machines Company of Salt Lake City, Utah. Other sources include Pultrex of Essex, England. Preferably, these machines are computer controlled by using winding software that is known in the art. For example, winding software is available under the tradenames CADWIND™ (Material S. A.; Brussels, Belgium), and WINDING GENIE™ (Composite Machines Company; Salt Lake City, Utah).

The twisting can take place at speeds between 10 and 250 rpm, and the winding angle may vary from 0° to 90°. Helical, circumferential, polar and non-linear winding paths can be employed.

Once the impregnated bundle has been twisted so that it has achieved a desired tautness, diameter, and length, a shroud is placed around the twisted bundle. The inner surface of the shroud will form the final cross-sectional shape of spring element 20. Accordingly, the shroud should completely encapsulate the impregnated tows.

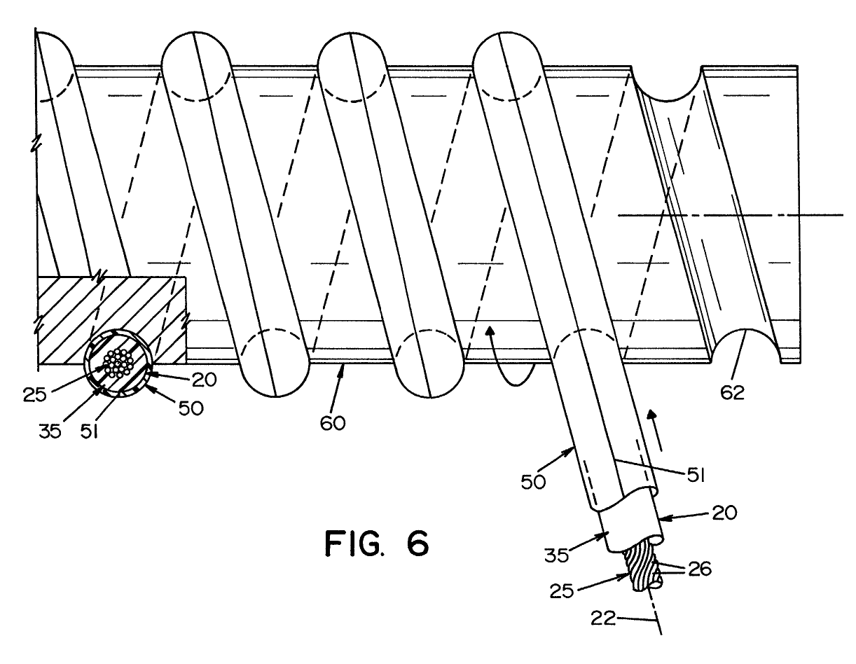

The shroud should be flexible enough to be wound in the form of a helical spring without forming any kinks or creases. One embodiment of this invention employs a shroud having a circular cross-section as shown in FIG. 6. Shroud 50 may comprise a piece of flexible tubing such as polyvinylchloride or neoprene tube. In practice, the tube is severed at location 51 along its longitudinal axis. This allows the tube to be opened and placed around the twisted bundle of tows while the integrity or elasticity of the tube allows it to close around and encase the bundled fibers. Alternatively, shrouds of desired cross-sectional shape can be extruded by using the appropriate single or twin screw extruder equipped with extrusion dyes. These dyes can be manufactured to induce the longitudinal slit on the shroud thus negating the step of longitudinal slitting described above.

Once the bundled fiber tows are encased within the shroud, the bundled tows may again be twisted. This twisting will decrease the diameter of the bundle and squeeze additional impregnated resin from the bundle. As a result, outer layer 35, which comprises resin, is formed between the twisted bundle fibers and the inner surface of the shroud. As the bundled yarns are continually twisted, the diameter of the bundled yarns will continue to decrease and the thickness of outer layer 35 will increase.

Once the bundled fibers have been twisted within the shroud to achieve a desired core diameter and outer layer thickness, the shroud, which encases the bundled fibers and resin, is wrapped around a mandrel 60 as shown in FIG. 6. This step of wrapping the shrouded resin/fiber composite around the mandrel can be accomplished by using various techniques. For example, a filament winding machine, a lathe or similar rotational device can be used for this purpose. If a proper mandrel is machined with a helical groove 62 of desired pitch that is deep enough to accommodate the shrouded fiber/resin composite, wrapping can also be done manually in this groove. Although a grooved mandrel is not required.

The shape and size of the mandrel is preselected based upon the desired shape and size of the spring. In order to prepare a conical spring, as shown in FIG. 4D, mandrel 60 would be a truncated cone, i.e., its diameter increases over its longitudinal axis, and therefore the resulting spring will be conical. The shape of the mandrel determines the shape of the spring to be made such as those shown in FIG. 4. The winding pitch over this mandrel, i.e., the helix angle, determines the number of coils that can be placed along a predetermined spring length. This, in turn, determines the magnitude of the spring constant. The spring constant increases linearly with a decreasing number of coils. The spring coil diameter and the wire diameter also impact the spring constant. The spring constant is inversely proportional to the third power of the coil radius, and directly proportional to the fourth power of the wire diameter. Composite springs of variable rate can be made by changing the winding pitch over the mandrel as desired. Preferably, the shroud is wrapped around the mandrel in a direction opposite to the direction that the bundle is twisted.

Once the shroud is wrapped around the mandrel, sufficient time should be provided for the resin to harden. Ideally, sufficient time should be provided so that the resin completely hardens. The step of hardening may take place at room temperature and atmospheric pressure. Depending on the resin employed, however, heat curing may be required. For example, many epoxy resins require cure at elevated temperatures as specified by the particular epoxy resin chosen.

Once the resin has sufficiently hardened, the shroud, which contains the bundled fibers and resins, is removed from the mandrel. This can be accomplished by initially separating the helical shroud manually from the mandrel, and subsequently by sliding it off the mandrel. In order to facilitate the removal of the shroud from the mandrel, a release agent such as Teflon spray may be applied to the mandrel before the shroud is wound onto the mandrel.

Once the shroud, which contains the bundled fibers and resin, is removed from the mandrel, the shroud should be removed from what is now the composite spring. In most situations, the shroud can be easily pulled away from the outer layer of the composite spring. In other situations, a solvent, which preferably dissolves the shroud material, can be employed. Also, it should be appreciated that in certain instances, the shroud could be removed from the composite spring while the composite spring remains on the mandrel. In this situation, the bundle should be longer than the shroud with its ends exposed out of the shroud. By fixing these bundle ends to the mandrel, the shroud can simply be pulled off the composite spring, which can remain on the mandrel. The composite spring is then subsequently removed by detaching and sliding it off of the mandrel.

In order to demonstrate the practice of the present invention, the following examples have been prepared and tested. The examples should not, however, be viewed as limiting the scope of the invention. The claims will serve to define the invention.

### GENERAL EXPERIMENTATION

The filament winding machine (Composite Machines Company, Salt lake city, UT) was the primary equipment used for our study. It is a 4-axes CMC controlled machine equipped with a 2-speed gearbox, which is capable of generating speeds up to 250 rpm. The horizontal and radial movement of the carriage, the rotating eye and the motion of the spindle (clockwise and anti-clockwise direction) constitute the four axes through which the filament winder can function.

The horizontal carriage could traverse from speeds as low as 10 mm/sec to as high as 1800 mm/sec. Objects up to 3.1 meters in length and 1.05 meters in diameter can be wound using this equipment. The winding angle varies from 0° to 90°. The real versatility of this machine is the ability to program it to generate various patterns using software such as CADWIND and WINDING GENIE with which it is equipped. Helical, circumferential, polar and even non-linear winding paths are available through this software. The features of each of the 4 axes of the filament winder as provided by the manufacturer are given in Table I.

TABLE I

| Axis | Specifications | Resolution |
|---|---|---|
| Spindle Rotation | Up to 250 rpm | 0.005°/bit |
| Horizontal Carriage | 1.78 m/s | 0.0127 mm/s |

Having arrived at the correct combination of epoxy and curing agent, the next step was to encase the fibers in this matrix and wind them by using suitable techniques to fabricate springs of helical configuration. Helical springs of three different coil and wire diameters were required. This was accomplished with the use of 3 different PVC pipes of outside diameters 37.05 mm, 42.5 mm and 48.45 mm which served as the mandrel to form the coil diameter when the actual winding was performed. Three different PVC tubing of 3.175 mm, 4.7625 mm, and 6.35 mm inside diameters were selected to form the spring wire diameter. By using an Xacto knife, a clean incision was made on the PVC tube. Care was taken to ensure that the incision was along a straight line, which would otherwise leave a poor surface finish on the spring wire.

The procedure for the fabrication of helical springs can be broken down into three stages. First, the number of glass/carbon fiber tows that could be accommodated within the tubing had to be determined. This was done by measuring the cross-sectional thickness of a fiber tows with a micrometer and comparing it with the inner diameter of the tubing into which it is to be enclosed. This provided insight as to the number of tows that were required to fill the PVC tube completely. While a decision on the approximate number of tows was being made, the reduction in diameter due to wetting by the epoxy was also taken into consideration. The fibers were then attached to specially made chucks. These chucks were made with cylindrical wooden bars into which a hole was drilled along its length. Metal roller bearings were fixed on the ends of the chucks. One of the chucks was attached to the headstock (moving) and the other to the tailstock (stationary) of the filament winder.

The second stage involved preparation of the epoxy resin bath, which was done by mixing together 88 grams of Epon 815-C and 12 grams of DETA by using a mechanical stirrer. This mixture was poured into a wide base aluminum pan. Subsequently, the fibers were immersed in the thermosetting resin solution and wetted thoroughly. These wetted fibers were then mounted back on to the winder and twisted either in the clockwise or anticlockwise direction. Care was taken to see that the direction in which fibers were rotated was kept the same throughout the study. In all our experiments, fibers were twisted in the clockwise direction, which results in a tightening action on the twisted tows when the helical springs in which they are encased are wound in counterclockwise direction and loaded in compression.

It was observed that after 28-30 rotations, the fibers were twisted taught enough that the tailstock began to rotate. It was at this point that further twisting was discontinued. In order to maintain a homogeneous fabrication technique, the number of rotations the fibers were subjected to was limited to 30. The slit PVC tube was then carefully slid on to the twisted fibers. At this stage, the fibers were further subjected to an additional five turns, which helped squeeze out the excess resin and compact the fiber bundle, thus imparting a cylindrical shape to the fibers.

In the third stage, the PVC pipe of a specific diameter (say 37.05 mm) was mounted on to the winder. The diameter of the pipe determines the coil diameter of the spring to be manufactured. In order to facilitate easy removal of the cured spring, the mandrel was sprayed with a mold release agent. Special software that was solely created for winding helical springs was used to wrap the fiber bundle around the mandrel at a precise winding angle and at a predetermined pitch (80° winding angle; 10° helix angle). The coils of the spring were wound in a direction opposite to the strand direction. This not only ensures the binding between strands but also the unwinding action that may be caused due to a twisting moment can be avoided when the spring is loaded in the compressive mode. The winding angle for all springs was set to 80°, which yielded a helix angle of 10°. The ends of the wound springs were fastened by an adhesive tape or clamped with binder clips. Care was taken to ensure that the ends of the springs were as flat as possible (helical angle=0°). This facilitated the subsequent experiments involving the determination of stiffness.

The specimens were allowed to cure at 30° C. and 35% relative humidity for over 12 hours. After complete curing, the PVC tubing was carefully peeled off leaving behind the fabricated spring. The above procedure was repeated with two other mandrels of diameters 42.5 mm and 48.45 mm. In order to make helical springs of varying wire diameters, PVC tubes of differing inner diameters were used. When larger diameter tubing was used, the number of tows of glass/carbon fibers had to be increased altering the stiffness of the spring. The required number of tows to fill the appropriate PVC tubing completely is illustrated in Table II.

TABLE II

| PVC tube (Inner diameter) | | Glass Fiber Tows | Carbon Fiber |
|---|---|---|---|
| 3.175 | mm | 10 | 2.5 |
| 4.7625 | mm | 22 | 5 |
| 6.35 | mm | 30 | 8 |

The same procedure was followed in order to make hybrid springs with glass and carbon fibers combined. For this purpose, the ratio of volume fractions of carbon to glass fiber tows had to be determined first. It was observed that the volume occupied by one tows of carbon fiber was approximately equivalent to that occupied by 4 tows of glass fibers. The combination of glass and carbon fibers that was used in the making of hybrid springs is depicted in Table III.

TABLE III

| PVC Tube (Inner diameter) | | Combination of Fibers used |
|---|---|---|
| 3.175 | mm | 6 Tows Glass Fibers + 1 |
| | | Tow Carbon Fibers |
| 4.7625 | mm | 12 Tows Glass Fibers + 2 |
| | | Tows Carbon Fibers |
| 6.35 | mm | 18 Tows Glass Fiber + 3 |
| | | Tows Carbon Fibers |

To measure the axial stiffness constant of the springs fabricated by the above-described procedure, an in-house testing set up was devised. This simple testing method consisted of constructing a solid steel platform on top of which was a fixed cylindrical bar. The diameter of the rod was chosen to accommodate all three helical springs of different coil diameters. Two aluminum plates of 8 cm 10 cm were used as endplates during stiffness measurements. A circular hole equivalent to the diameter of the cylindrical bar was drilled in the center of the two aluminum plates. On one of the plates two small holes were drilled on either sides to facilitate the application of weights.

The helical spring having a wire diameter of 3.175 mm was placed in between these two plates and the length of the helical spring was measured with a micrometer. This initial condition is referred to as the “no-load” or unstressed condition. Precise loads ranging from 20 grams to 1000 grams were used in subsequent measurements to load the spring in compression axially. These loads were applied on either sides of the top plate and the weights used for loading were gradually increased from 20 grams to 2000 grams in increments. The corresponding displacements of the spring were measured with a micrometer. With the initial length of the spring and the subsequent displacements, the deflection that the spring underwent for specific loads was determined.

With this data, a plot of load versus deflection was made and the slope of this plot gives an estimate of the stiffness constant for the helical spring. The above procedure was carried out for a spring having 7 active turns. The same procedure was repeated by cutting off turns of the original spring to study the stiffness constants for 6, 5 and 4 active turns (coils). This method of testing was found to be ideal for determining the stiffness constant of springs with small wire diameters. Also, the procedure used was checked for consistency by subjecting the same spring to different loading patterns. The repeated values obtained under differing conditions proved the accuracy of the testing procedure that was used. For larger wire diameter springs such as 4.7625 mm and 6.35-mm diameters, a similar procedure was used with an Instron 4204 tensile tester.

In order to evaluate and compare the theoretical stiffness for different composite helical springs, Young's modulus, bulk modulus, transverse stiffness and shear modulus for the composite are needed. The calculation of these parameters necessitates that the volume fractions of the fibers and epoxy be known. This was accomplished by making use of the procedure described below.

One complete coil of the fabricated spring was cut and its length was measured with a plastic string. An equal length of glass and/or carbon fibers was selected, and since the number of tows used for that particular spring was known, the amount of fibers present in the matrix could be found. The single coil was also weighed and the difference between the two above-mentioned quantities gave the amount of adhesive that was incorporated into the matrix. Since the weight and density of the materials are known, the volume fractions of the fiber and matrix could be calculated.

The shear modulus, G₂₃, values were calculated for the spring wire material based on the experimentally determined volume fraction and spring stiffness values. These values were found to increase linearly with increasing coil diameters, while the G₂₃ values showed a decreasing trend with the wire diameter.

The shear modulus of hybrid strings measured experimentally were found to be very close to what was obtained by using the rule of mixtures, which calculates the composite modulus as the addition of the contribution from individual fiber components as porportional to their volume fraction in the total volume of fibers in the composite spring.

A cross-sectional area of the fabricated helical spring was sectioned and viewed under a Scanning Electron Microscope (SEM) to determine the position and distribution of glass fibers in the epoxy matrix and also to assess the size of the epoxy layer. For this purpose, a Hitachi S-1250 SEM was used along with a Polaron coating system that helped to sputter the samples. The SEM photographs confirmed that the fibers were concentrated in the center, and encased in an epoxy outer layer.

While the best mode and preferred embodiment of the invention have been set forth in accord with the Patent Statues, the scope of this invention is not limited thereto, but rather is defined by the attached claims. Thus, the scope of the invention includes all modifications and variations that may fall within the scope of the claims.

What is claimed is:

1. A fiber-reinforced composite spring comprising:
a coiled spring wire that comprises
a fiber-reinforced core having longitudinal axis, where said core comprises core-reinforcing fiber tows that are twisted about the longitudinal axis of said core; and
an outer layer surrounding said fiber-reinforced core, where said outer layer comprises a resin that is devoid of fiber tows.

2. The composite spring of claim 1, where said outer layer has a smooth surface.

3. The composite spring of claim 2, where said smoother outer layer has a uniform thickness.

4. The composite spring of claim 1, where the fiber-reinforced composite spring has a predictable rate.

5. The composite spring of claim 3, where said uniform thickness does not vary by more than 10% over the longitudinal axis of the spring wire.

6. The composite spring of claim 1, where the coiled spring wire has a circular cross-section.

7. The composite spring of claim 1, where the coiled spring wire has a rectangular cross-seciton.

8. The composite spring of claim 1, where the core-reinforcing fiber tows comprise natural or synthetic fibers.

9. The composite spring of claim 8, where said natural fibers are selected from jute and rayon fibers.

10. The composite spring of claim 8, where said synthetic fibers are selected from glass, carbon, boron, silicon carbide, aluminum oxide, quartz, alumina-silica, alumina-boria-silica, zerconia-silica, and fused silica fibers.

11. The composite spring of claim 1, where said resin is a thermosetting resin or a themoplastic resin.

12. The composite spring of claim 11, where said thermosetting resin is selected from epoxy, bis-maleimide, polyimide, polyester, and vinyl ester resins, as well as polyether, ether ketone, polyphenylene sulfide, polyetherimide, and polyamide imide resins.

13. A fiber-reinforced composite spring formed by a process comprising the steps of:
impregnating a bundle of fiber tows with a thermosetting resin composition to form a bundle of impregnated fiber tows;
twisting the bundle of impregnated fibers to form a twisted bundle of fibers;
applying a shroud over the twisted bundle of fibers;
twisting the twisted bundle of fibers within the shroud;
winding the twisted bundle of fibers within the shroud around a mandrel to form a pre-set coil;
allowing the pre-set coil to cure; and
removing the shroud.

14. The composite spring of claim 13, where said step of impregnating a bundle of fiber tows includes pultrusion.

15. The composite spring of claim 13, where said step of twisting the bundle inlcudes using a filament winding machine.

16. The composite spring of claim 13, where said shroud inlcude a piece of flexible tubing.

17. A process for forming a fiber-reinforced composite spring comprising the steps of:
impregnating a bundle of fiber tows with a thermosetting resin composition to form a bundle of impregnated fiber tows;
twisting the bundle of impregnated fibers to form a twisted bundle of fibers;
applying a shroud over the twisted bundle of fibers;
twisting the twisted bundle of fibers within the shroud;
winding the twisted bundle of fibers within the shroud around a mandrel to form a pre-set coil;
allowing the pre-set coil to cure; and
removing the shroud.

18. The process of claim 17, where said step of impregnating a bundle of fiber tows includes pultrusion.

19. The process of claim 17, where said step of twisting the bundle inlcudes using a filament winding machine.

20. The process of claim 17, where said shroud inlcude a piece of flexible tubing.
